(19) United States
(12) Patent Application Publication
(10) Pub. No.: US 2012/0288339 A1
(43) Pub. Date: Nov. 15, 2012

(54) DEVICE FOR COLLECTING THE DEBRIS PRODUCED DURING DRILLING OPERATIONS

(76) Inventor: Paul Manet, Nancy (FR)

(21) Appl. No.: 13/520,571

(22) PCT Filed: Jan. 14, 2011
(86) PCT No.: PCT/FR2011/000018

§ 371 Date: Jul. 4, 2012

(30) Foreign Application Priority Data
Jan. 15, 2010 (FR) 1050254

(51) Int. Cl. B23B 47/00; B23B 35/00

(52) U.S. Cl. 408/1 R; 408/67

(57) ABSTRACT

The invention relates to a device for automatically collecting the debris generated during drilling operations performed using a drilling means, characterised in that said device includes a container made of a deformable material, which comprises: an adhesive means arranged on at least one of the external surfaces of the container, said adhesive means enabling the container to be attached to the substrate to be drilled; a rigid or semi-rigid means extending in the inner space of said container, which includes a transversely aligned projection, the walls of which are made of a material that enables, when drilling the projection, the formation of blades that extend near the through-opening created while drilling; a flexible means, such as filaments, extending under the projection; the blades and the flexible means are arranged such that the free ends thereof engage with the external surface of the through-element of the drilling means when the latter passes through the container coaxially with the projection, the blades enabling the retention of the debris produced in the inner space of the container while the flexible means enables, by friction with said external surface of the drilling means, the separation of the debris therefrom.

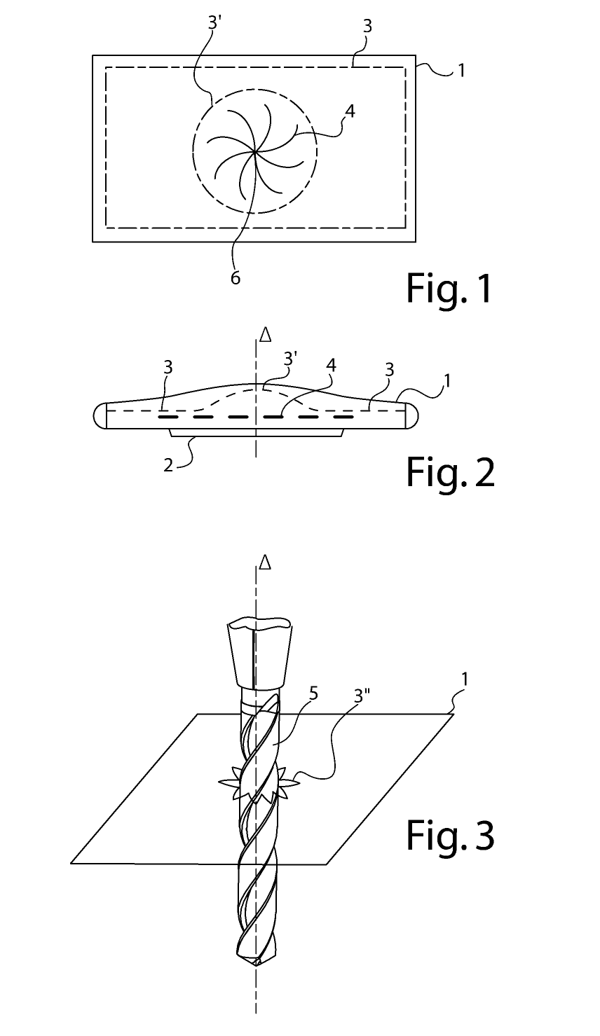

The present invention has as an aim a device making it possible to collect the refuse generated at the time of operations of drilling. It relates in particular, but not exclusively, to a device making it possible to collect dust, generated particles, and chips when one bores walls, partitions, surfaces made of plaster, stone, cellular concrete, wood, metal, etc.

One knows that it is highly recommended to carry, during the realization of such work of drilling, safety goggles with broad cover in order to protect the eyes of the operators, from projections. However, the wearing of this type of glasses is often uncomfortable and impractical because in particular of their dimensions and the condensation which obstructs the vision.

Moreover, whether one carries or not glasses, the refuse produced at the time of the operations of drilling is projected in the air before settling on the ground, which can cause respiratory disorders, and requires carrying out cleaning with the assistance generally of a brush or a vacuum cleaner.

The invention aims thus more particularly to solve these problems by proposing a simple and inexpensive device in particular making it possible to avoid projection in the air of particles.

At this purpose, the invention proposes a device making it possible automatically to collect the refuse generated at the time of operations of drilling carried out using means of drilling, characterized in that it includes a receptacle made up of a deformable material, which comprises:
adhesive means laid out on at least one of the its external faces, these adhesive means allowing to fix it on the support to be bored;
rigid or semi-rigid means extending in the interior space of the aforesaid receptacle, which includes a protuberance centred transversally, whose walls consist of a material which allows, possibly following a pre-treatment, to constitute, during the drilling of the protuberance, strips which extend near the crossing opening created at the time of the aforesaid drilling;
flexible means, such as filaments, extending under the protuberance;
   the strips as well as the flexible means are laid out in such a way that their loose leads are in contact with the external surface of the crossing element of the means of drilling when this latter coaxially crosses the receptacle to the protuberance, the strips making it possible to maintain the refuse produced in the interior space of the receptacle whereas the flexible means, while coming to rub the aforementioned external surface of the means of drilling, make it possible to detach the refuse from them.

Preferentially, the walls of the receptacle, the adhesive means and the walls of the protuberance consist of a transparent material making it possible to the users to locate the zone to be bored after having laid out the device according to the invention on this zone.

In this manner, the device according to the invention advantageously makes it possible to the operator to use his two hands to hold the means of drilling and to direct with precision the crossing element of this latter. Moreover, it will not be compulsary to carry safety goggles or to carry out a cleaning of the refuse after the operation of drilling is finished, the latter remaining in the interior space defined by the aforementioned receptacle.

Process of the invention will be described hereafter, by way of non-restrictive examples, with reference to the annexed drawings in which:

FIG. (1) is a diagrammatic representation, top view, of the device according to the invention.

FIG. (2) is a diagrammatic representation, side view, of the device according to the invention, with a description of its components.

FIG. (3) is a diagrammatic representation of the device according to the invention, crossed by the crossing element of drilling means.

In this example, such as is represented in particular on FIGS. (1) and (2), the device according to the invention comprises a receptacle consisting of an envelope (1) which constitutes a small pouch preferably made up of a flexible and transparent plastic material, such as for example P.E.T. “polyethylene terephthalate”, the elements of this envelope (1) being able to be sealed thermically.

Such as it is represented in particular on FIG. (1), envelope (1) can show a rectangular form, but it can also show various forms such as for example, square, circular ones, etc.

The receptacle comprises:
adhesive means (2) laid out on at least one of the external faces of envelope 1, these adhesive means (2) allowing to fix it on the support to be bored; these adhesive means (2) can consist of a double face adhesive tape preferentially transparent, provided with a protective film covering its external face; in this way, after having withdrawn the protective film, the operator can stick with precision the device according to the invention on the zone to be bored;
rigid or semi-rigid means (3) extending in the interior space of the aforesaid receptacle, which includes a protuberance (3′) centred transversally, whose walls consist of a material which allows, to constitute, during the drilling of the protuberance (3′), strips (3″) which extend near the crossing opening created at the time of the aforesaid drilling;
flexible means (4), such as filaments, extending under the protuberance (3″) ; in the case in point, these filaments (4) appear in a plan appreciably parallel with that of the aforementioned envelope (1), and show each one the shape of a spiral whose central point (6) is crossed by the central axis (Δ) of the protuberance (3′).

The walls of the protuberance (3′) consist of a material which allows, preferentially following a pre-treatment, to constitute, during the drilling of the protuberance (3′), the aforementioned strips (3″) which extend near the crossing opening created at the time of the aforesaid drilling. Thus, as an example, these walls can consist of plastic, rigid or semi rigid materials, and pre-grooved in order to adapt to dimensions and the rotation speed of the crossing elements (5), the aforementioned strips (3″) thus being able to be pre-cut out.

A drilling by using the device according to the invention results in the realization of the following stages:
the operator fixes the device according to the invention on the zone to bore after having centred it thanks to the transparency of the components of the aforesaid device according to the invention, the axis of the zone to be bored having appreciably to be the same as that of the central axis (Δ) of the protuberance (3′)
the end of the crossing element (5) of the means of drilling (not represented) is placed so as to be in contact with the external wall of the receptacle, this crossing element (5) extending in order to be appreciably coaxial with the central axis (Δ) of the protuberance (3′);
the starting of the means of drilling;
the successive drilling of the upper wall of the receptacle, of the wall of the protuberance (3′), of the central point (6) of the flexible means (4), of the adhesive means (2), and of the zone to be bored;
the constitution during the drilling of the wall of the protuberance (3′), of strips (3″) whose loose leads come to rub the edges of the crossing element (5);
licking off by the ends of the flexible means (4) of the edges of the crossing element (5), following the drilling of the central point (6) of these flexible means (4);
the swelling of the envelope (1) under the combined action of frictions of the ends of the strips (3″) and the flexible means (4) against the external surface of the crossing element (5) in rotation;
the containment of the refuse generated during drilling in the interior space of the receptacle: the ends of the flexible means (4) detach these refuse from the external surface of the crossing element (5), whereas the strips (3″) as well as the adhesive means (2) make it possible to prevent that these refuse arise from the interior space of the receptacle, these adhesive means (2) thus having the advantage of providing a function of fixing of the device according to the invention but also a function of preserving of the sealing during drilling;
the stop of the operation of the means of drilling when drilling is finished;
the withdrawal of the device according to the invention, this latter which can be re-used or thrown, refuse generated during drilling being possibly recovered, in particular when they present a certain value.

In this manner, the use of the device according to the invention advantageously makes it possible to avoid the projection of the rubble generated at the time of the operations of drilling, which allows in particular:
to avoid the use of cumbersome safety goggles or masks, the risk to ingest dust being practically non existent;
to carry out drillings in inhabited places because of the absence of projections in the ambient air, which avoids the need of carrying out a cleaning once the operation of drilling is finished.

The means of drilling and the crossing element (5) can respectively be, as an example, a drilling machine and a drill.

In an advantageous way, the device according to the invention allows the professionals and the private individuals to carry out various work of drilling in full safety.

The device according to the invention can be used in all the current positions of drilling.

1. Device allowing to collect the refuse generated at the time of operations of drilling carried out using means of drilling,
characterized in that it includes a receptacle made up of a deformable material, which comprises:
adhesive means laid out on one of its external faces, these adhesive means allowing to fix it on the support to be bored;
rigid or semi rigid means extending in interior space of the aforesaid receptacle, which includes a protuberance transversally centred, whose walls consist of a material which makes it possible to constitute, during the drilling of the protuberance, strips which extend near the crossing opening created at the time of the aforesaid drilling;
flexible means, such as filaments, extending under the protuberance;
the strips as well as the flexible means are laid out in such a way that their loose leads are in contact with the external surface of the crossing element of the means of drilling when this latter coaxially crosses the receptacle and the protuberance, the strips making it possible to maintain the refuse produced in the interior space of the receptacle whereas the flexible means, while coming to rub the aforementioned external surface of the means of drilling, make it possible to detach the refuse from them.

2. Device according to claim 1,
characterized in that the walls of the receptacle, the adhesive means, and the walls of the protuberance consist of a transparent material making it possible to the users to locate the zone to be bored after having laid out the device according to the invention on this zone.

3. Device according to claim 1,
characterized in that it comprises a receptacle including an envelope which constitutes a small pouch.

4. Device according to claim 3,
characterized in that the envelope is made up of flexible and transparent plastic material, elements of this envelope being able to be sealed thermically

5. Device according to claim 1,
characterized in that:
the adhesive means consist of a double face adhesive tape preferentially transparent, provided with a protective film covering its external face; in this way, after having withdrawn the protective film, the operator can stick with precision the device according to the invention on the zone to be bored;
the filaments appear in a plan appreciably parallel with that of the aforementioned envelope, and present each one the shape of a spiral whose central point is crossed by the central axis of the protuberance.

6. Device according to claim 1,
characterized in that the walls of the protuberance consist of a material which allows, following pre-treatment, to constitute, during the drilling of the protuberance, the aforementioned strips which extend near the crossing opening created at the time of the aforesaid drilling; these walls consist of plastic material, rigid or semi rigid, and being pre-grooved in order to be adapted to the dimensions and the rotation speed of the crossing elements, the aforementioned strips thus being able to be pre-cut out.

7. Device according to claim 1,
characterized in that the means of drilling and the crossing element are respectively a drilling machine and a drill.

8. Use of the device such as defined in claim 1, in order to automatically collect the refuse generated at the time of operations of drilling carried out using means of drilling,
characterized in that a drilling by using the device according to the invention results in the realization of the following stages:
the operator fixes the device according to the invention on of the zone to bore after having centred it thanks to the transparency of the components of the aforesaid device according to the invention, the axis of the zone to be bored being appreciably the same as that of the central axis of the protuberance;
the end of the crossing element of the means of drilling is placed so as to be in contact with the external wall of the receptacle, this crossing element extending in order to be appreciably coaxial with the central axis of the protuberance;
the starting of the means of drilling;
the successive drilling of the upper wall of the receptacle, of the wall of the protuberance, of the central point of the flexible means, of the adhesive means, and of the zone to be bored;
the constitution during the drilling of the partition of the protuberance, of strips whose loose leads come to rub the edges of the crossing element;
the licking by the ends of the flexible means of the edges of the crossing element, following the drilling of the central point of these flexible means;
the swelling of the envelope under the combined action of frictions of the ends of the strips and of the flexible means against the external surface of the crossing element in rotation;
the containment of the refuse generated during drilling in the interior space of the receptacle: the ends of the flexible means detach these refuse of the external surface of the crossing element, whereas the strips as well as the adhesive means make it possible to prevent that this refuse arise from the interior space of the receptacle, these adhesive means thus having the advantage of providing a function of fixing of the device according to the invention but also a function of preserving of the sealing during drilling;
the stop of the operation of the means of drilling when drilling is finished;
the withdrawal of the device, this latter which can be re-used or thrown.
